(19) United States
(12) Patent Application Publication
(10) Pub. No.: US 2005/0174917 A1
(43) Pub. Date: Aug. 11, 2005

(54) Hologram type optical recording medium, manufacturing method and reproducing apparatus therefor

(76) Inventors: Kazuki Matsumoto, Kanagawa (JP); Katsutaro Ichihara, Kanagawa (JP); Akiko Hirao, Chiba (JP); Rumiko Hayase, Kanagawa (JP); Takayuki Tsukamoto, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/038,516

(22) Filed: Jan. 21, 2005

(30) Foreign Application Priority Data
Jan. 23, 2004 (JP) 2004-016248

(51) Int. Cl. G11B 7/00

(52) U.S. Cl. 369/103

(57) ABSTRACT

An optical recording medium has a recording layer recording information as hologram by receiving a beam of light corresponding to the information. The recording layer includes a plurality of recording areas which are physically separated in a direction, the direction is substantially parallel to a surface that the beam of light enters and a boundary area provided between the recording areas to separate the respective recording areas.

### CROSS-REFERENCE TO RELATED APPLICATIONS

This application is based upon and claims the benefit of priority from the prior Japanese Patent Application No. 2004-016248, filed on Jan. 23^{rd}, 2004; the entire content of which is incorporated herein by reference.

### BACKGROUND OF THE INVENTION

1) Field of the Invention

The present invention relates to holographic data storage technology.

2) Description of the Related Art

Conventionally, optical recording media are known as which can store high density data such as image data.

For example, rewritable optical recording media such as a magneto-optical disk and phase-change optical disk, and recordable optical recording media such as a CD-R have already been put into practical use.

Recently, a demand for capacity of optical recording media has increased. Then, holographic data storage that can record data volumetrically has been remarked (e.g., see Japanese Patent Application Laid-Open Publication No. 2002-123949). When recording data in holographic media, generally, information beam provided with a two-dimensional intensity distribution and reference beam having substantially uniform intensity are superposed within a photosensitive recording layer. Then, utilizing an interference pattern formed by the information beam and the reference beam, an optical characteristic distribution is produced within the recording layer.

More specifically, holographic media using a radical polymerization photopolymer will be described. When the information beam and the reference beam are superposed in a recording layer formed by a photopolymer, differences in intensity of light are produced by interference. At a part strongly irradiated with light, radicals are produced from a photo initiator, and polymerization of radical polymerization monomers progresses in a chain reaction with the radicals as a trigger. Then, with the progress of the polymerization of radical polymerization monomers, radical polymerization monomers are diffused from a part weakly irradiated with light to the part strongly irradiated with light to form concentration gradient of radical polymerization monomers. In other words, density differences of radical polymerization monomers are produced according to the intensity differences of interference light, and, as a result, a hologram is formed as differences in refractive index.

On the other hand, when reading data written in holographic media, only the reference beam is irradiated to the recording layer in the same arrangement as recording. The reference beam is modulated by the hologram formed in the recording layer. Then, reproduction beam having an intensity distribution corresponding to the information beam is output from the recording layer.

In this technology, since the volumetric optical characteristic distribution is formed within the recording layer, multiple recording is possible. Here, the multiple recording refers to partial superposition of an area in which data are written by predetermined information beam and an area in which other data are written by other information beam.

In particular, when digital volume holography is employed, original information can be reproduced with accurately even if the signal-to-noise ratio (SN ratio) is relatively low, and the recording capacity of optical recording media can be increased significantly.

### SUMMARY OF THE INVENTION

According to one aspect of the present invention, an optical recording medium includes a recording layer recording information as hologram by receiving a beam of light corresponding to the information, the recording layer including: a plurality of recording areas which are physically separated in a direction, the direction is substantially parallel to a surface that the beam of light enters; and a boundary area provided between the recording areas to separate the respective recording areas.

According to another aspect of the present invention, a manufacturing method of an optical recording medium having a recording layer that records information as hologram by receiving a beam of light corresponding to the information, the method includes forming a plurality of recording areas which record the information; and forming a boundary area that physically separates the respective recording areas in a direction, the direction being substantially parallel to a surface that the beam of light enters.

According to still another aspect of the present invention, a holographic optical recording and reproducing apparatus for recording information on an optical recording medium including a recording layer that records information as hologram by receiving a beam of light corresponding to the information, the recording layer including a plurality of recording areas and a boundary area, the plurality of recording areas are physically separated in a direction, the direction being substantially parallel to a surface that the beam of light enters, and the boundary area provided between the recording areas to separate the respective recording areas, the holographic optical recording and reproducing apparatus includes an edge detecting unit that detects a edge of the recording area using the beam of light; and a beam applying unit that applies the beam of light in a position at inner side of the edge of the recording area detected by the edge detecting unit.

### BRIEF DESCRIPTION OF THE DRAWINGS

FIG. 1 is a schematic sectional view of an optical recording medium according to the first embodiment;

FIG. 2 is a plan view of a recording layer shown in FIG. 1 seen from a direction perpendicular to a first principal surface;

FIG. 3 is a partially enlarged view of the recording layer shown in FIG. 2;

FIG. 4 is a view of a recording layer of an optical recording medium according to the second embodiment;

FIG. 5 is a view of a recording layer of an optical recording medium according to the third embodiment;

FIG. 6 is a view of a recording layer of an optical recording medium according to the fourth embodiment;

FIG. 7 is a sectional view of an optical recording medium according to the fifth embodiment;

FIG. 8 is a diagram showing a relationship between the size of a recording area and the maximum spot size of information beam;

FIG. 9 is a partial sectional view of the optical recording medium showing the relationship between writing beams and the optical recording medium when information is recorded by angular multiple recording;

FIG. 10 is a diagram showing a relationship between the optimum size of the recording area and the maximum spot size of information beam when information is recorded by shift multiple recording;

FIG. 11 is a diagram showing the relationship between writing beams and the optical recording medium when information is recorded by shift multiple recording;

FIG. 12 is a diagram for the explanation of the starting position for recording in the recording area;

FIG. 13 is a diagram for the explanation of the starting position for recording in an optical recording and reproducing apparatus using the reflective optical recording medium shown in FIG. 7;

FIG. 14 is a diagram for the explanation of a manufacturing method according to the first embodiment of the optical recording medium;

FIG. 15 is a diagram for the explanation of a manufacturing method according to the first embodiment of the optical recording medium;

FIG. 16 is a diagram for the explanation of a manufacturing method according to the first embodiment of the optical recording medium;

FIGS. 17 and 18 are diagrams for the explanation of a manufacturing method according to the second embodiment of the optical recording medium;

FIG. 19 is a diagram for the explanation of a manufacturing method according to the third embodiment of the optical recording medium;

FIG. 20 is a diagram for the explanation of a manufacturing method according to the third embodiment of the optical recording medium;

FIG. 21 is a diagram for the explanation of a manufacturing method according to the third embodiment of the optical recording medium;

FIG. 22 is a diagram for the explanation of a manufacturing method according to the third embodiment of the optical recording medium;

FIG. 23 is a diagram for the explanation of a manufacturing method according to the fourth embodiment of the optical recording medium;

FIG. 24 is a diagram for the explanation of a manufacturing method according to the fourth embodiment of the optical recording medium;

FIG. 25 is a diagram for the explanation of a manufacturing method according to the fourth embodiment of the optical recording medium;

FIG. 26 is a schematic diagram of an example of a holographic recording and reproducing apparatus 1 that can mount the transmissive optical recording medium shown in FIG. 1;

FIG. 27 is a schematic diagram of an example of a holographic recording and reproducing apparatus that can mount the reflective optical recording medium having a reflecting layer shown in FIG. 7;

FIG. 28 is a diagram of that depicts the shape of a spacer according to the example 1;

FIG. 29 is a diagram for the explanation of a manufacturing method of an optical recording medium according to the example 1;

FIG. 30 is a graph of an example of diffraction efficiency when angular multiple recording and reproduction is performed on the optical recording medium, according to the example 1;

FIG. 31 is a diagram of the shape of a spacer according to the comparative example 1; and

FIG. 32 is a graph of an example of diffraction efficiency when shift multiple recording and reproduction is performed on an optical recording medium, according to the example 2.

### DETAILED DESCRIPTION

Hereinafter, exemplary embodiments relating to the invention will be described in detail with reference to the drawings.

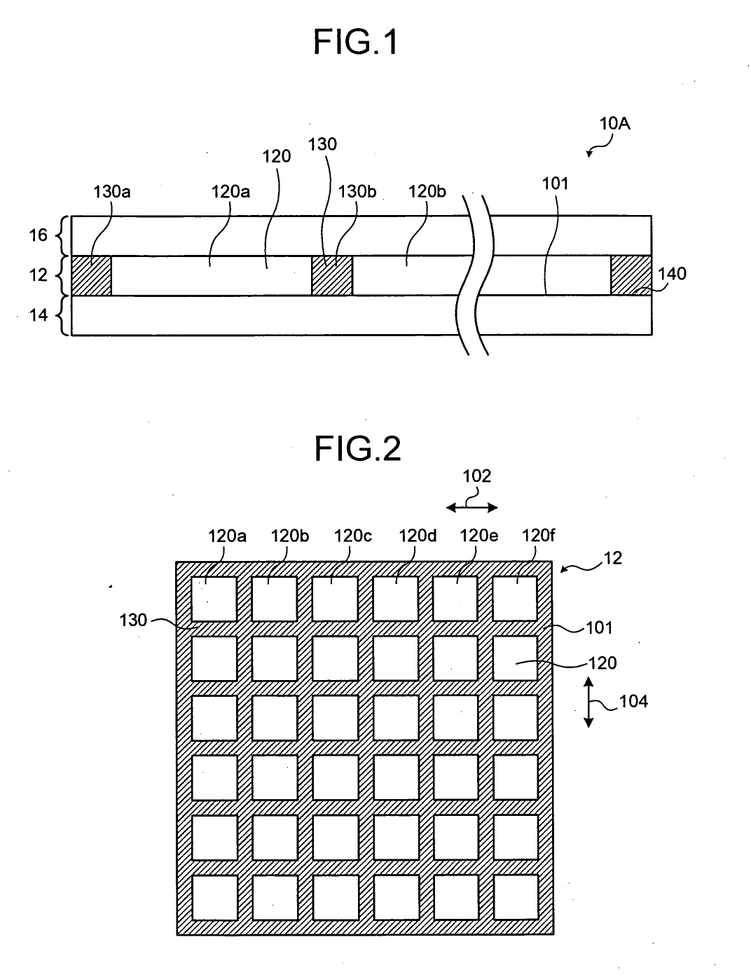

FIG. 1 is a schematic sectional view of a hologram type optical recording medium according to the first embodiment. An optical recording medium 10A includes a transparent substrate 14. The transparent substrate 14 has a first principal surface 140, on which a recording layer 12 and a protecting layer 16 are sequentially laminated.

Further, the recording layer 12 has plural recording areas 120's, respectively denoted by reference numbers, 120a, 120b, . . . and a boundary area 130, which is divided into plural boundary areas 130a, 130b, . . . . The recording area 120 is an area for recording information utilizing holography. Each recording area 120 is surrounded by the boundary area 130. Thereby, each recording area 120 is physically separated from other recording areas 120's. Thus, because the respective recording areas 120's are separated from each other, one recording area 120 can be handled as one hypothetical optical recording medium. When the amount of information to be recorded is larger than the capacity of one recording area 120, one piece of information may be recorded over the plural recording areas 120's.

FIG. 2 is a plan view of the recording layer 12 shown in FIG. 1 seen from a direction perpendicular to a first principal surface 101 of the recording layer 12.

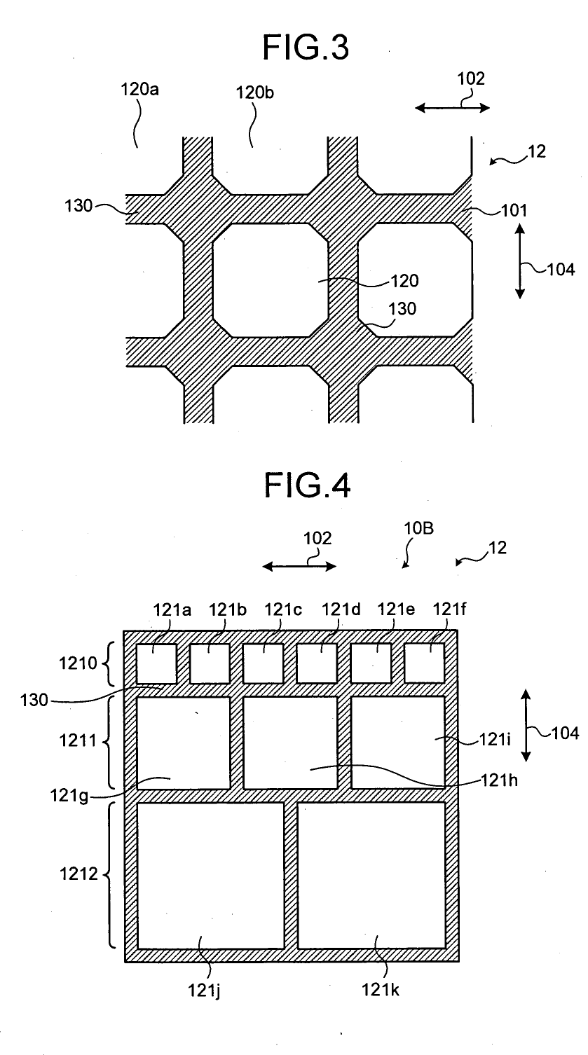

FIG. 3 is a partial enlarged view of the recording layer 12 shown in FIG. 2. The recording layer 12 is formed in a rectangular shape. Further, the recording layer 12 has plural recording areas 120a, 120b, . . . and the boundary area 130.

The boundary area 130 physically separate the recording areas 120's from each other. In the recording layer 12 shown in FIGS. 2 and 3, the boundary area 130 are formed at even intervals in a lateral scanning direction 102 and a longitudinal scanning direction 104. Here, the lateral scanning direction 102 and the longitudinal scanning direction 104 are directions in which recording beam is made to run for scanning when the optical recording medium 10A is mounted on an optical recording and reproducing apparatus. The boundary area 130 is formed along the scanning directions.

In the recording layer 12 according to the first embodiment, six recording areas 120's are located along the lateral scanning direction 102 and along the longitudinal scanning direction 104 in the first principal surface 101. Hence, the recording layer 12 has 36 recording areas 120's. Each recording area 120 is formed approximately in a rectangular shape and respective areas of the respective recording areas 120's are approximately the same. Three-dimensionally, the recording areas 120's are approximately the same in volume.

Thus, in the recording layer 12 according to the embodiment, any one of the respective recording areas 120's is located independently from other recording areas 120's by the boundary area 130. Thereby, even when one recording area 120 is irradiated with recording beam and radicals are generated, the radicals can be prevented from moving to other recording areas 120's.

Once information is recorded in the recording area 120, in other words, once the recording beam is applied thereto, the radicals generated then are diffused to unrecorded areas in which no data has been written yet. Hence, the recording performance of the unrecorded areas is deteriorated. However, according to the embodiment, because the respective recording areas 120's are independently formed, when the recording beam is applied to a certain recording area 120, thus generated radicals would not be diffused to other recording areas, and the recording performance in the recording areas other than the recording area irradiated with the recording beam can be maintained. Thus, recordability of the optical recording medium 10A can be enhanced.

Further, since the optical recording medium 10A has physically separated plural recording areas 120's, the optical recording medium 10A can be handled as plural hypothetical optical recording media, and information management can be facilitated. Further, accessibility to the information recorded in the optical recording medium 10A can be enhanced.

The recording area 120 according to the embodiment contains a photopolymer as a material. As a material of the recording area 120, it is desirable to use a material that changes optical characteristics, such as an absorption coefficient and a refractive index, according to the irradiation intensity when electromagnetic wave of a predetermined wavelength is applied, in order to block the propagation of the recording beam in directions within the surface in the recording area 120. Specifically, the material of the recording area 120 may be, other than the photopolymer, an organic material such as a photo-refractive polymer and a photochromic dye dispersing polymer or an inorganic material such as lithium niobate and barium titanate, for example.

As a material of the boundary area 130, it is desirable to use a material containing, for example, a metal, a metal oxide such as silicon oxide, titanium oxide, magnesium oxide, aluminum oxide, a metal fluoride such as magnesium fluoride and calcium fluoride, a synthetic resin such as ion-exchange resin, fluorocarbon resin, polycarbonate, and acrylic resin, or the like.

Note that the material of the boundary area 130 is not particularly limited as long as a material can suppress the diffusion of the radicals and acids generated in the recording areas 120's and suppress the lateral propagation of the recording beam.

In view of suppressing the diffusion of radicals or acids, the material of the boundary area 130 desirably indicates different density, solubility parameter, or the like from the material of the recording area 120.

Furthermore, in view of suppressing the lateral propagation of the recording beam, the material of the boundary area 130 desirably indicates an absorption coefficient larger than the absorption coefficient indicated by the material of the recording area 120 in the wavelength of the recording beam. Preferably, it is desired that the material of the boundary area 130 indicates the absorption coefficient ten times or larger compared to the absorption coefficient indicated by the material of the recording area 120 in the wavelength of the recording beam. Similarly, the recording area 120 and the boundary area 130 preferably indicate different refractive indices. Alternatively, no material may be filled in the boundary area 130. That is, the boundary area 130 may be a vacant holes.

As a material of the transparent substrate 14, a material transparent to the recording beam and advantageous in mechanical strength is desirable. As such a material, specifically, polycarbonate or glass is generally used for the optical recording medium.

As a material of the protecting layer 16, the same transparent material as that generally used for the optical recording medium, for example, polycarbonate, silicon oxide, or the like is desirable.

The optical recording medium 10A described in reference to FIGS. 1, 2, and 3 is an example, and various changes or modifications can be made.

For example, the recording layer 12 according to the embodiment has 36 recording areas 120's of the same size, however, the number and the size of the recording areas 120's are not limited by the embodiment. For example, four recording areas 120's may be arranged in the lateral scanning direction 102 and the longitudinal direction 104, respectively, and a total of 16 recording areas may be formed. Further, plural recording areas in different sizes may be formed.

FIG. 4 is a recording layer 12 of an optical recording medium 10B according to the second embodiment. FIG. 4 is a plan view of the recording layer 12 seen from a direction perpendicular to a first principal surface 101. The recording layer 12 according to the second embodiment has plural recording areas 121's similarly to the recording layer 12 according to the first embodiment described in FIG. 2. Note that the recording layer 12 according to the second embodiment has plural recording areas 121's being different in size. The recording layer 12 shown in FIG. 4 has six recording areas 121a to 121f in an upper level 1210. The length of the sides of the recording areas 121a to 121f is one-sixth the length of a side of the recording layer 12 in the lateral scanning direction 102, i.e., the lateral side. Further, in a middle level 1211, the layer has three recording areas 121g to 121i with one-third the length of the lateral side of the recording layer 12 as the length of one side. Furthermore, in a lower level 1212, the layer has two recording areas 121j and 121k with one-half the length of the lateral side of the recording layer 12 as the length of one side.

Thus, the recording layer 12 according to the second embodiment has plural recording areas 121a to 121k having different recording capacities. Accordingly, the optical recording medium 10B can be handled as hypothetical optical recording media with different recording capacities. Therefore, by selecting a recording area 120 having a size suitable for the size of the information to be recorded, the waste of recording capacity can be minimized. Thus, the medium can be handled as an optical recording medium on which optical recording media such as a CD-R, DVD-R, or the like with different recording capacities are mounted together.

The recording layer 12 according to the second embodiment has the recording areas 121g to 121k having larger areas than the area of the recording area 120 of the recording layer 12 according to the first embodiment described in FIGS. 2 and 3 as the minimum area. In other words, the recording areas occupy a larger area in the recording layer 12 of FIG. 14 than in the recording layer 12 described in FIGS. 2 and 3. Thus, the recording capacity can be made larger.

The structure of other parts of the recording layer 12 according to the second embodiment is the same as that of the recording layer 12 according to the first embodiment described in reference to FIGS. 2 and 3. Further, the structure of the optical recording medium 10B according to the second embodiment is the same as the structure of the optical recording medium 10A according to the first embodiment described in reference to FIG. 1.

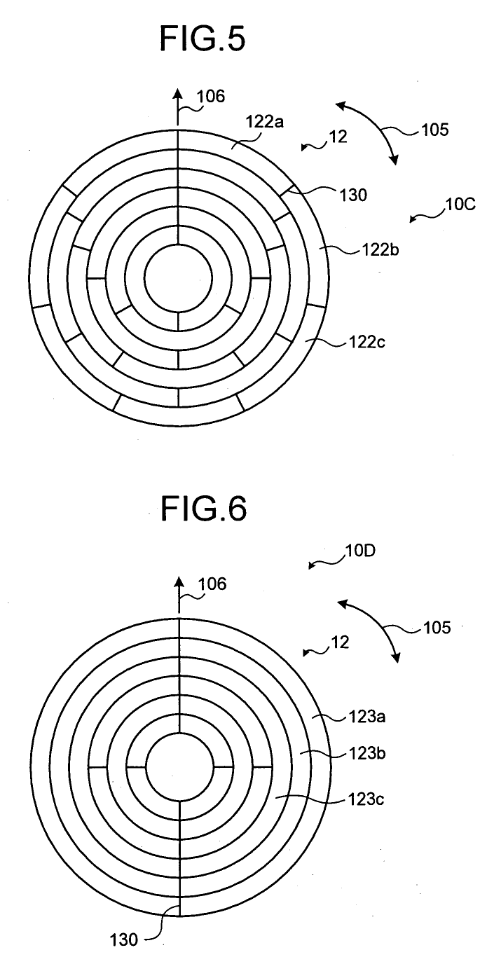

FIG. 5 is a diagram of a recording layer 12 of an optical recording medium 10C according to the third embodiment. FIG. 5 is a plan view of the recording layer 12 seen from a direction perpendicular to a first principal surface 101 of the recording layer 12. The recording layer 12 according to the third embodiment is formed in a disk shape. Further, boundary areas 130's are formed in a circumferential direction 105 and a radial direction 106 of the disk. Thereby, physically separated 27 recording areas 122's are formed. Further, the respective recording areas 122's are formed so as to have nearly equal areas. Thus, in the disk-shaped recording layer 12, plural recording areas same in size can be formed as in the recording layer 12 shown in FIG. 2.

Here, the circumferential direction 105 and the radial direction 106 correspond to the directions in which recording beam is made to run at the scanning when the optical recording medium 10C including the recording layer 12 is mounted on the optical recording and reproducing apparatus.

In the recording layer 12 according to the third embodiment, as in the recording area shown in FIG. 2, each recording area 122 can be handled as one hypothetical optical recording medium. Further, since it has plural recording areas 122's, the information management in the optical recording medium 10C can be facilitated and the accessibility to the information recorded in the optical recording medium 10C can be improved. In addition, the recordability of the optical recording medium 10C can be enhanced compared with an optical recording medium having only one recording area 122 in the recording layer 12.

The structure of other part of the recording layer 12 according to the third embodiment is the same as that of the recording layer. 12 according to the first embodiment described in reference to FIGS. 2 and 3. Further, the structure of the optical recording medium 10C according to the third embodiment is the same as the structure of the optical recording medium 10A according to the first embodiment described in reference to FIG. 1.

FIG. 6 is a diagram of a recording layer 12 of an optical recording medium 10D according to the fourth embodiment. FIG. 6 is a plan view of the recording layer 12 seen from a direction perpendicular to a first principal surface 101. The recording layer 12 according to the fourth embodiment is formed in a disk shape similarly to the recording layer 12 according to the third embodiment. Note that the recording layer 12 according to the fourth embodiment has plural recording areas 123a, 123b, . . . having different areas. In this point, the recording layer according to the fourth embodiment is different from the recording layer 12 according to the third embodiment. The structure of other parts of the recording layer 12 according to the fourth embodiment is the same as that of the recording layer 12 according to the third embodiment described in reference to FIG. 5. Further, the structure of the optical recording medium 10D according to the fourth embodiment is the same as the structure of the optical recording medium 10A according to the first embodiment described in reference to FIG. 1.

In any of the embodiment described above, the example in which the boundary areas 130's are formed along the scanning directions are described, however, the directions of the boundary areas 130's are not limited to those. In other words, as long as the recording layer 12 have plural recording areas, the number and shapes of the recording areas are not limited by the embodiment.

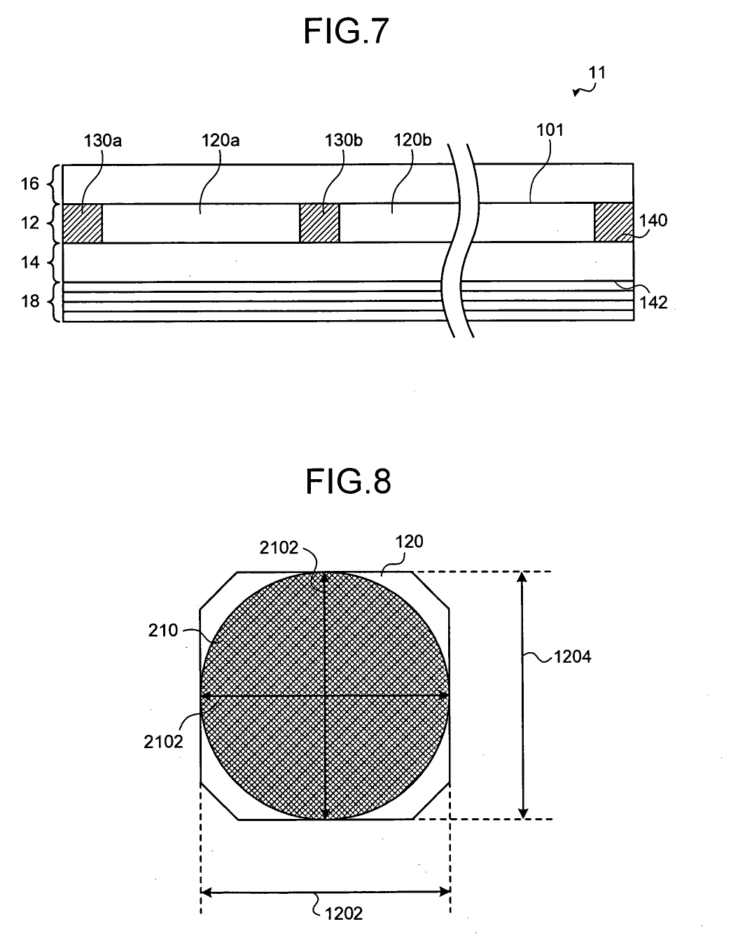

FIG. 7 is a sectional view of an optical recording medium 11 according to the fifth embodiment. The optical recording medium 11 according to the fifth embodiment further includes a reflecting layer 18 on the side of a second surface 142 opposite to a first principal surface 140 of a transparent substrate 14. Hence, the optical recording medium 11 according to the fifth embodiment is a reflective optical recording medium. As a material of the reflecting layer 18, a material having a high reflectance to the recording beam applied to the optical recording medium 11 is desirable. For example, aluminum or the like is desirable.

Next, the optimum size of the recording area 120 will be described. FIG. 8 is a diagram that depicts the relationship between the size of the recording area 120 and the maximum spot size of information beam 210. As shown in FIG. 8, a lateral side 1202 of each recording area 120 is formed in the same length as a diameter 2102 of the maximum spot of the information beam 210. Similarly, a longitudinal side 1204 is formed in the same length as the diameter 2102 of the maximum spot of the information beam 210. Here, the lateral side 1202 and the longitudinal side 1204 may be formed slightly longer than the diameter 2102 of the maximum spot providing the margins corresponding to the errors in the position to be irradiated with the information beam 210. Thus, the length of the lateral side 1202 of each recording area 120 is preferably equal to or longer than the diameter 2102 of the maximum spot of the information beam 210. Similarly, the length of the longitudinal side 1204 is preferably equal to or longer than the diameter 2102 of the maximum spot of the information beam 210.

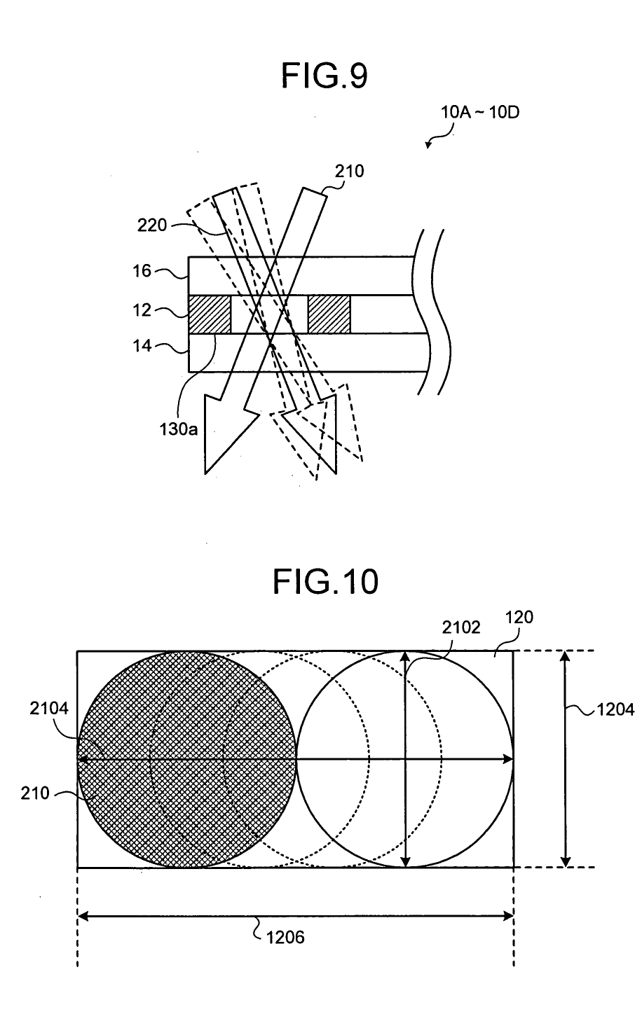

FIG. 9 is a partial sectional view of the optical recording media 10A to 10D. As shown in FIG. 9, by applying the information beam 210 and the reference beam 220 to the recording area 120, information is recorded in the recording area 120. When information is recorded in the optical recording medium 10 by the angular multiple recording, with the change in the angle of irradiation of the reference beam 220, which is made according to the information to be recorded, the angle of superposition of the information beam 210 and the reference beam 220 in the recording area 120 changes accordingly to form different interference patterns. Thereby, plural different pieces of information can be superposed and recorded in the same recording area 120.

Mainly, as methods of angular multiple recording, there are a method for recording different pieces of information in the same volume of the recording area 120 by fixing the optical recording media 10A to 10D and the information beam 210 and changing the angle of the reference beam 220, and a method for recording different pieces of information in the same volume of the recording area 120 by fixing the information beam 210 and the reference beam 220 and changing the angles of the optical recording media 10A to 10D.

In either case, when a part of the information beam 210 is applied to the outside of the recording area 120, i.e., boundary area 130, a disturbance of light is caused, and the information is not recorded accurately. Therefore, as shown in FIG. 8, it is desired that the lengths of the respective sides of the respective recording areas 120's are provided as lengths equal to or longer than the diameter of the maximum spot of the information beam 210.

Furthermore, in view of recording information in space of the recording area 120 without waste, that is, recording as much information as possible, each side of the recording area 120 in the embodiments is desirably formed in substantially the same length as the diameter of the maximum spot of the information beam 210. Further, when each side is made longer than that, each side of the recording area 120 in the embodiments is desirably formed in an integral multiple of the diameter of the maximum spot of the information beam 210. Here, the lateral side 1202 and the longitudinal side 1204 of the recording area 120 may be formed in different lengths, respectively.

Further, as another example, information may be recorded by shift multiple recording instead of angular multiple recording. FIG. 10 is a diagram that depicts the relationship between the optimum size of the recording area 120 and the maximum spot size of information beam 210 when information is recorded by the shift multiple recording.

As shown in FIG. 10, a lateral side 1206 of each recording area 120 is formed in the same length as a length 2104, which is twice the diameter 2102 of the maximum spot of the information beam 210. Further, a longitudinal side 1204 is formed in the same length as the diameter 2102 of the maximum spot of the information beam 210. To accommodate margins, they may be formed slightly longer than the respective lengths. Thus, the length of the lateral side 1206 is desirably a length equal to or more than the length 2104, which is twice the diameter of the maximum spot of the information beam 210. Further, the length of the longitudinal side 1204 is desirably a length equal to or more than the diameter 2102 of the maximum spot of the information beam 210.

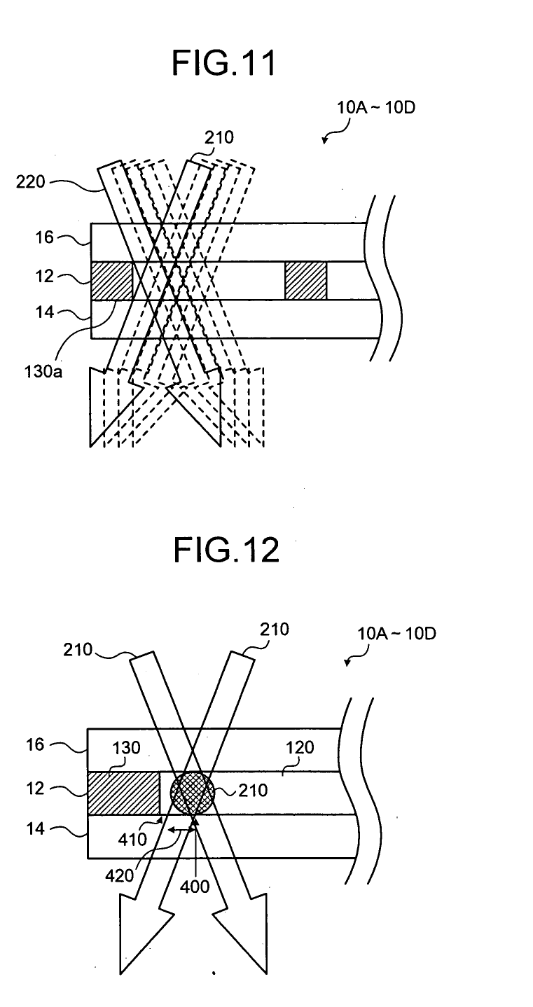

In the case of the shift multiple recording, information is recorded by superposing the information beam 210 and the reference beam 220 in the recording area 120 as in the case of angular multiple recording. In the shift multiple recording, as shown FIG. 11, the relationship between the beams and the optical recording media 10A to 10D are maintained. Through the gradual shift of the irradiated positions with the information beam and the reference beam in the optical recording media 10A to 10D in the lateral scanning direction 102, different pieces of information are recorded within the same recording area 120. Here, the moving distances of the irradiated positions of the information beam and the reference beam are shorter than the maximum spot size of the information beam 210, and thereby, plural pieces of information are superposed and recorded in the same area.

In the shift multiple recording, in view of efficiently recording information in space of the recording area 120, it is desired that the lateral side 1206 of the recording area 120 has a length twice as long as the diameter of the maximum spot of the information beam 210. In other words, it is desired that the length of the recording area 120 in the shift direction has a length twice as long as the diameter of the maximum spot of the information beam 210. Thereby, the shift multiple recording can be performed in space of the recording area 120 without waste.

Furthermore, the length of each side may be made longer. When the length of the lateral side 1206 is made equal to or longer than twice the length of the diameter of the maximum spot of the information beam 210, more information can be recorded and the efficiency of the shift multiple recording can be improved compared with the case where the lateral side 1206 is made in a length shorter than twice the length of the diameter.

Furthermore, in view of recording more information, when the length of the lateral side 1206 is made longer, it is desirably an integral multiple of the diameter of the maximum spot of the information beam 210. Similarly, when the length of the longitudinal side 1204 is made longer, it is desirably an integral multiple of the diameter of the maximum spot of the information beam 210.

Note that the shape of the outer edge of the recording area 120 is not limited to the rectangular shape. The recording area 120 may be formed in any shape and size that includes the information beam 210 at least inside of the recording area 120. More desirably, the shape of the outer edge and the size of the recording area 120 and the diameter of the maximum spot of the information beam 210 may have the relationships described.

Next, referring to FIG. 12, in the optical recording and reproducing apparatus mounting the optical recording media 10A to 10D including recording layers 12, the starting position for recording at the recording in the recording area 120 will be described. FIG. 12 is a diagram for the explanation of the starting position for recording in the recording area 120. The optical recording and reproducing apparatus will be described later.

As shown in FIG. 12, a position inner from a boundary position 410 between the boundary area 130 and the recording area 120 by the length 420 of the radius of the maximum spot of the information beam 210 is defined as a starting position for recording 400. When the information beam 210 is applied to the boundary area 130, a disturbance of light might be caused and recording accuracy might be deteriorated. Therefore, it is desired that the information beam 210 is applied so that the periphery of the maximum spot of the information beam 210 may fall within the recording area 120. In view of this, it is desired that irradiation of the information beam 210 starts from the position inside of the recording area 120 by the radius of the maximum spot of the information beam 210. Thereby, the described problems can be solved.

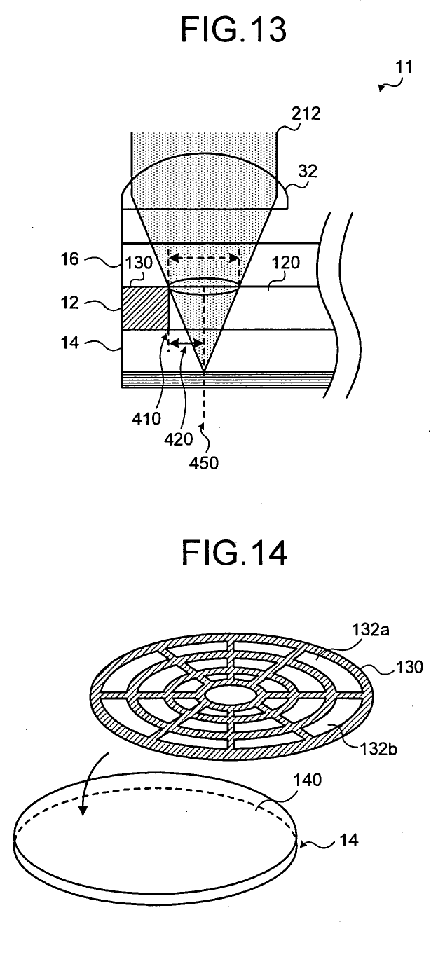

FIG. 13 is a diagram for the explanation of the starting position for recording in an optical recording and reproducing apparatus using the reflective optical recording medium shown in FIG. 7. As similarly described in FIG. 12, a position inner from a boundary position 410 between the boundary area 130 and the recording area 120 by the length 420 of the radius of the maximum spot of the information beam 212 is defined as a starting position for recording 450. Thereby, as is the case of the optical recording media 10A to 10D shown in FIG. 12, information beam 212 can be avoided from irradiating the boundary area 130.

Though in the above description, the starting position for recording has been described by referring to FIGS. 12 and 13, the same applies to an end position for recording where the irradiation of the information beam must be ended in one recording area 120. In other words, when the beam moves to the position inside of the recording area from a boundary position between the boundary area 130 and the recording area 120 by the length of the radius of the maximum spot of the information beam 210, irradiation of the information beam is ended. Thereby, information beam can be avoided from irradiating the boundary area 130.

Next, the first embodiment of a manufacturing method of an optical recording medium will be described. Here, the optical recording medium 10D according to the fourth embodiment described in FIG. 6 will be described as an example.

First, a sheet-like boundary area 130 as shown in FIG. 14 is formed. The boundary area 130 has physically separated plural vacant holes 132a, 132b, . . . corresponding to the number of the recording areas 120's. The boundary area 130 is placed on the first principal surface 140 of the transparent substrate 14.

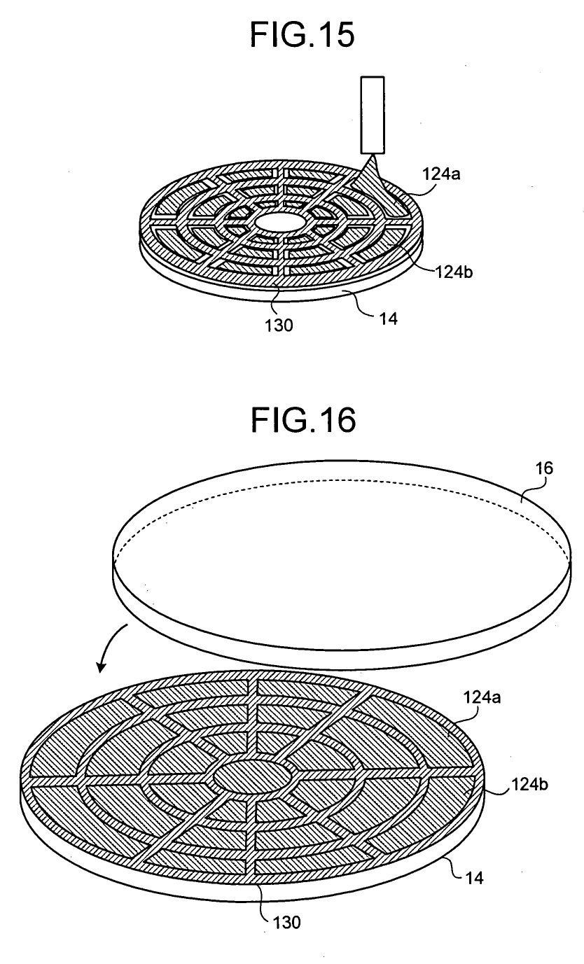

Then, as shown in FIG. 15, a raw material solution for forming the recording areas 120's is cast as to fill the plural vacant holes 132a, 132b, . . . of the boundary area 130, respectively. Thereby, the vacant holes 132a, 132b, . . . are filled with certain volumes of undiluted solution 124a, 124b, . . . , respectively.

Next, as shown in FIG. 16, the protecting layer 16 is laminated on the recording layer 12 filled with the raw material solution for the recording area 120. Thereby, the optical recording medium 10D is formed.

The manufacturing method of the optical recording medium 10D described by referring to FIG. 13 to 15 is only an example, and various changes and modifications can be made.

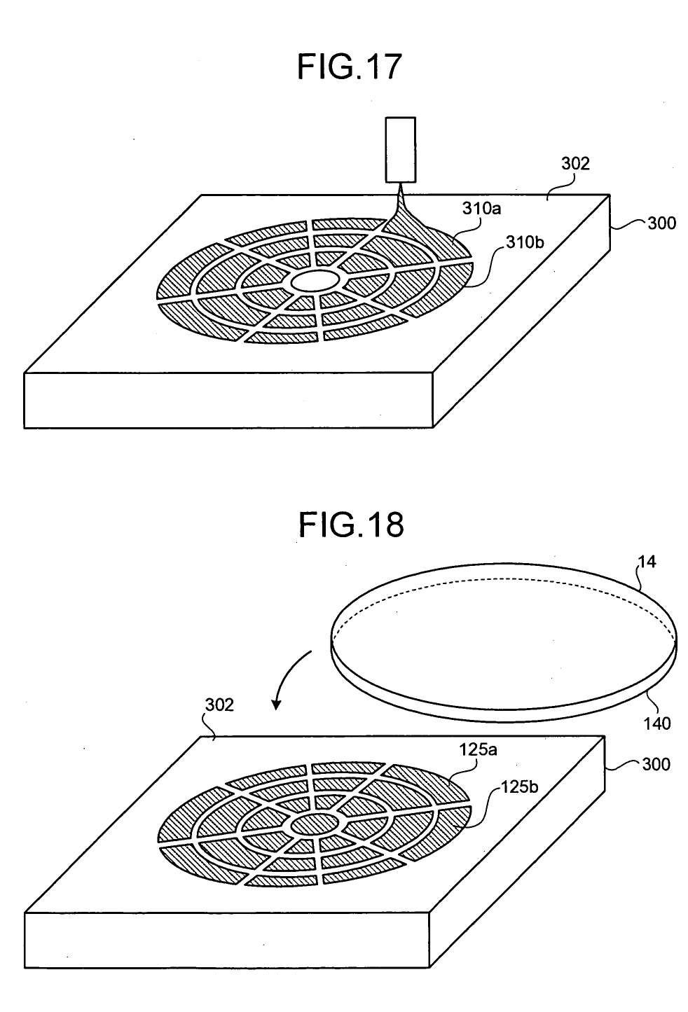

FIG. 17 is a diagram that depicts the second embodiment of a manufacturing method of the optical recording medium 10D. In the manufacturing method according to the second embodiment, first, a metal mold 300 shown in FIG. 17 is formed. The metal mold 300 has physically separated plural reservoirs 310a, 310b, . . . corresponding to the number of the recording areas 120's in a first principal surface 302. The respective reservoirs 310a, 310b, . . . are formed in recessed shapes. The respective reservoirs 310a, 310b, . . . are filled with the raw material solution for the recording areas 120's. Then, as shown in FIG. 18, the transparent substrate 14 is made in close contact with the first principal surface 302 of the metal mold 300 filled with the raw material solution for the recording areas 120's. Thereby, plural recording areas 125a, 125b, . . . are formed. Then, by detaching the metal mold 300 and laminating the protecting layer 16 on the surface opposite to the surface in close contact with the transparent substrate 14, the optical recording medium 10D is formed.

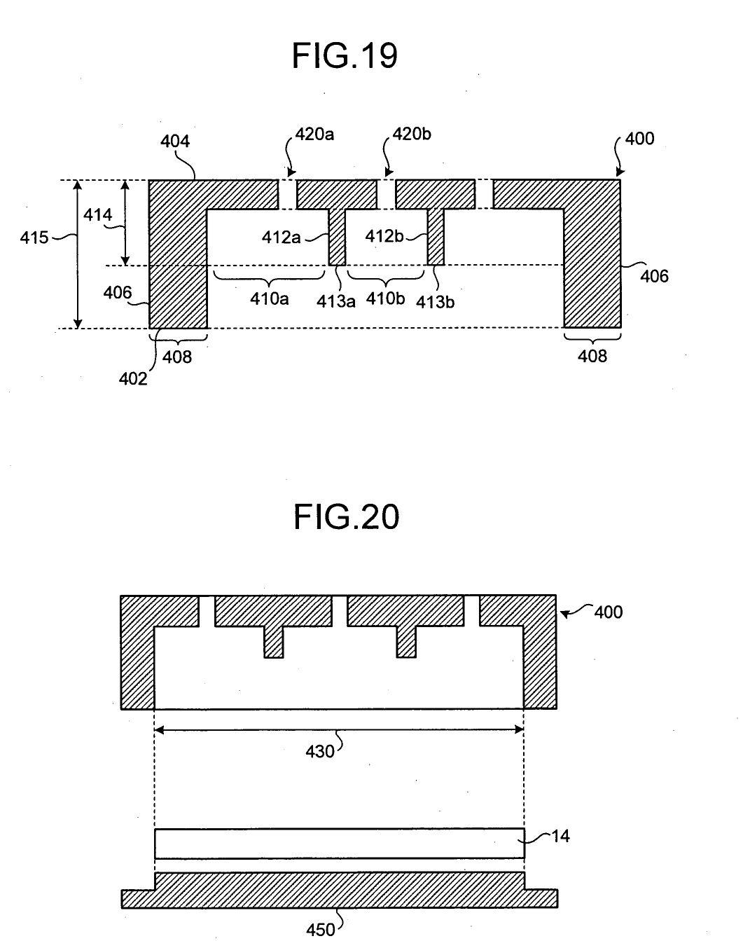

FIG. 19 is a diagram that depicts a manufacturing method according to the third embodiment of the optical recording medium 10D. In the manufacturing method according to the third embodiment, first, a metal mold 400 in a shape corresponding to the recording areas as shown in FIG. 18 is formed. In the metal mold 400, a recessed part is formed at the center with an area 408 including a side surface 406 left. Then, in the recessed part, physically separated plural reservoirs 410a, 410b, . . . corresponding to the number of the recording areas 120 are formed. Protruding portions 412a, 412b, . . . that separate the respective reservoirs 410a, 410b, . . . are formed so that the distances from a second principal surface 404 to upper surfaces 413a, 413b, . . . of the respective protruding portions 412a, 412b, . . . may be all equal. Furthermore, the protruding portions 412a, 412b, . . . are formed so that distances 414 from the second principal surface 404 to the upper surfaces 413a, 413b, . . . may be formed so as to be shorter than a distance 415 from the second principal surface 404 to the first principal surface 402.

Furthermore, on the second principal surface 404 of the metal mold 400 provided on the opposite side to the first principal surface 402 on which the respective reservoirs 410a, 410b, . . . are formed, resin filling ports 420a, 420b, . . . that penetrate to the respective reservoirs 410a, 410b, . . . are formed.

First, as shown in FIG. 20, the transparent substrate 14 is fit into an inner diameter 430 of the area 408 including the side surface 406 of the metal mold 400. Here, the transparent substrate 14 is formed in a diameter equal to the inner diameter 430 of the area 408. Thereby, the first principal surface 402 sides of the reservoirs 410a, 410b, . . . are blocked. Further, a metal mold 450 formed in the same diameter as that of the transparent substrate 14 is fit into the inner side of the area 408 in which the transparent 14 is fit.

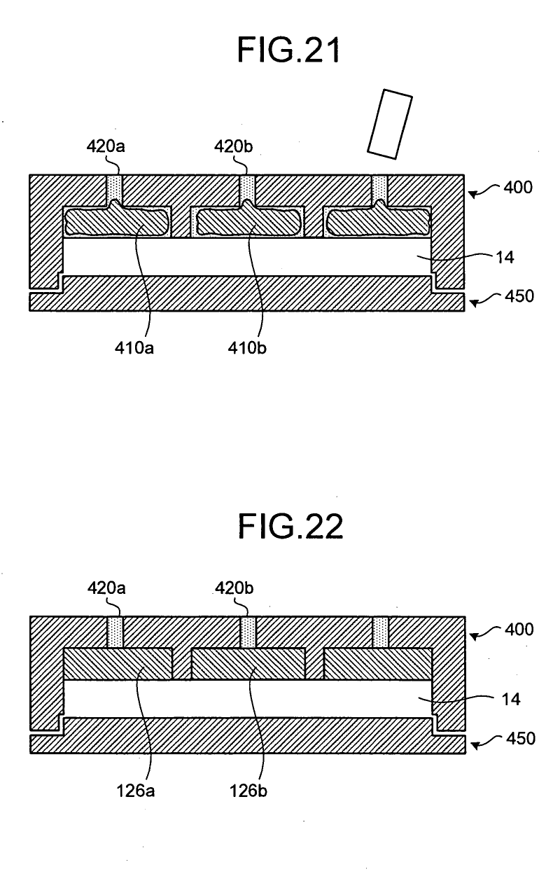

Thereby, as shown in FIG. 21, the first principal surface 402 side is sealed. Then, the raw material solution for the recording areas 120's is injected from the resin filling ports 420a, 420b, . . . formed on the second principal surface 404 to the respective reservoirs 410a, 410b, . . . . Thereby, as shown in FIG. 22, recording areas 126a, 126b, . . . are formed. Then, by detaching the metal mold 400 and the metal mold 450 and laminating the protecting layer 16 on the surface opposite to the surface in close contact with the transparent substrate 14, the optical recording medium 10D is formed.

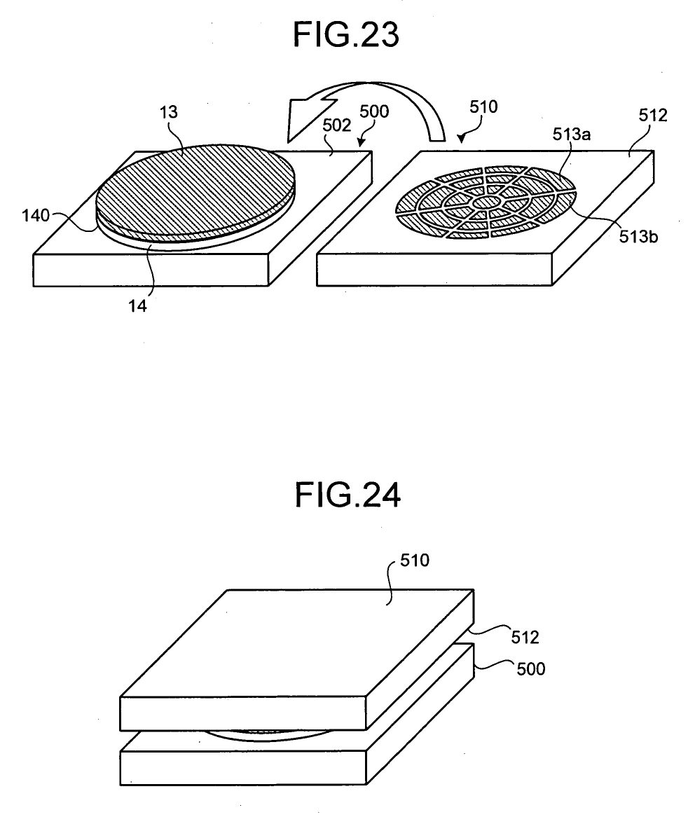

FIGS. 23, 24, and 25 are diagrams that depict a manufacturing method according to the fourth embodiment of the optical recording medium 10D. In the manufacturing method according to the fourth embodiment, the disk-shaped transparent substrate 14 is mounted on a first principal surface 502 of a first metal mold 500. Further, a recording layer 13 is laminated on a first principal surface 140 of the transparent substrate 14.

On the other hand, a metal mold 510 same as the metal mold 300 described in FIG. 17 is formed. The.metal mold 510 has plural reservoirs 513a, 513b, . . . corresponding to the number of the recording areas 120's on a first principal surface 512.

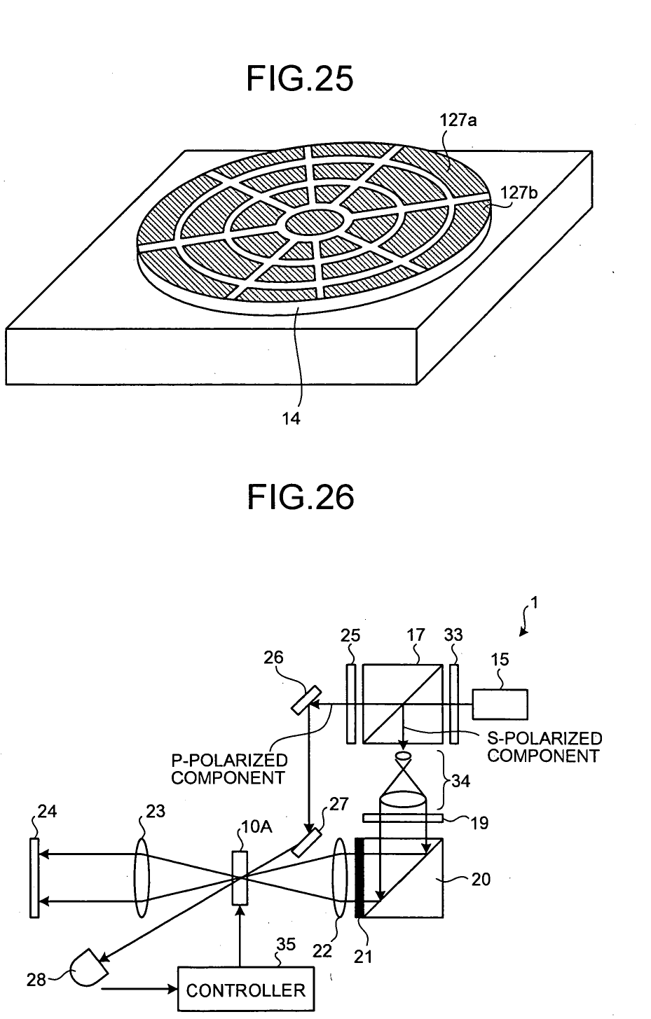

Then, as shown in FIG. 24, using a technique of imprinting for pressing the first principal surface 512 of the second metal mold 510 against the recording layer 13 from above, the recording layer 13 is divided into plural pieces. Thus, plural recording areas corresponding to the reservoirs 513a, 513b, . . . can be formed in the recording layer 13. Thereby, as shown in FIG. 25, plural recording areas 127a, 127b, . . . are formed. Further, by laminating the protecting layer 16, the optical recording medium 10D is formed.

Note that, in the respective manufacturing methods as described above, a heating unit that can heat the formed recording area 120 to a temperature equal to or higher than glass transition temperature or a cooling unit can be used.

Further, in the manufacturing methods according to the third embodiment, and the fourth embodiment, the boundary area 130 may be formed after the formation of the recording areas 120's. As a forming method of the boundary area 130, for example, deposition, sputtering, spin coating, casting, injection molding, or the like can be used. Alternatively, the boundary area 130 may not be filled with a material purposely, and the air may be used as the boundary area.

The hologram type optical recording medium according to the present embodiment can be mounted on the optical recording and reproducing apparatus described hereinbelow, for example. FIG. 26 schematically is an example of the hologram type optical recording and reproducing apparatus 1 that can mount the transmissive optical recording medium 10A shown in FIG. 1. A recording method using the hologram type optical recording and reproducing apparatus will be described.

This hologram type optical recording and reproducing apparatus 1 includes the optical recording medium 10A, a light source 15, an optical element 33 for optical rotation, a polarizing beam splitter 17, a beam expander 34, a transmissive spatial light modulator 19, a polarizing beam splitter 20, an electromagnetic shutter 21, an objective lens 22, an imaging lens 23, a two-dimensional photodetector 24, an optical element 25 for optical rotation, a mirror 26, a mirror 27, and a photodetector 28.

As the light source 15, a laser that outputs coherent linear polarized beam is desirably used. As the laser, for example, a semiconductor laser, He—Ne laser, argon laser, YAG laser, or the like can be used.

A beam output from the light source 15 has a plane of polarization rotated, or is circularly polarized or elliptically polarized by the optical element 33 for optical rotation and becomes a beam including a polarization component with a plane of polarization in parallel with the paper surface (hereinafter, referred to as “P-polarized component”), and a polarization component with a plane of polarization perpendicular to the paper surface (hereinafter, referred to as “S-polarized component”). As the optical element 33 for optical rotation, for example, a half-wave plate or quarter-wave plate can be used.

The polarizing beam splitter 17 reflects the S-polarized component of the beam output from the optical element 33 for optical rotation. The beam expander 34 increases the beam diameter of the S-polarized component. Then, the S-polarized component enters the transmissive spatial light modulator 19 as a parallel luminous flux.

Further, the P-polarized component of the beam is transmitted through the polarizing beam splitter 17. This P-polarized component is utilized as reference beam.

The transmissive spatial light modulator 19 has many pixels arranged in a matrix form like a transmissive liquid crystal display device, for example. The transmissive spatial light modulator 19 switches output light of the beam entering the transmissive spatial light modulator 19 between the P-polarized component and the S-polarized component with respect to each pixel. The transmissive spatial light modulator 19 outputs information beam provided with a two-dimensional distribution of plane of polarization corresponding to the information to be recorded by the above constitution.

The information beam output from the transmissive spatial light modulator 19 then enters the polarizing beam splitter 20. The polarizing beam splitter 20 reflects only the S-polarized component and transmits the P-polarized component of the information beam.

The S-polarized component reflected by the polarizing beam splitter 20 passes through the electromagnetic shutter 21 as information beam provided with a two-dimensional intensity distribution. Then, the component is applied to the recording area of the optical recording medium 10A by the objective lens 22.

On the other hand, the P-polarized component (reference beam) transmitted through the polarizing beam splitter 17 has its plane of polarization rotated by 900 by the optical element 25 for optical rotation and becomes S-polarized beam. Then, the beam is applied by the mirror 26 and the mirror 27 so as to superpose with the information beam within the recording area of the optical recording medium 10A. Within the recording area, the information beam and reference beam interfere. Thereby, an optical characteristic distribution corresponding to the information beam is produced.

The information recorded by the above described method can be read out in the following manner. First, the electromagnetic shutter 21 is closed and only the reference beam is applied to the recording area 120 in which the information is recorded previously. Then, the reference beam is diffracted by the optical characteristic distribution produced within the recording area, and output as reproduction beam from the optical recording medium 10A. The reproduction beam output from the optical recording medium 10A reproduces the information beam. This information beam is imaged by the imaging lens 23 so as to reproduce the image of the transmissive spatial light modulator 19 on the two-dimensional photodetector 24. Thus, the information recorded in the optical recording medium 10A is read out.

Note that, in the recording and reproducing apparatus 1 mounting the optical recording medium 10A, an end of the recording area can be detected utilizing at least one of the information beam and the reference beam at the time of writing. Thereby, the position to be irradiated with beam can be located. Further, the starting position for recording 450 described in FIG. 12 can be located. Here, a light source for detecting the end of the recording area 120 may be provided separately.

As a detecting method of the end of the recording area, there is a method based on the output of the light intensity transmitted through an optical medium monitored by the photodetector 28. When servo beam or reference beam used as servo beam illuminates the end of the recording area, beam is scattered strongly. Thereby, a spike output is obtained from the photodetector 28. Using this spike output as a detection signal of the end of the recording area, the end of the recording area can be detected. In this case, a controller 35 determines the starting position for recording 450 based on the position of the end located based on the output of the photodetector 28. Then, based on the determined position, the controller 35 controls the beam irradiated position in the optical recording medium 10A. The controller 35 determines the end position for recording similarly, and controls the end position for beam irradiation.

Furthermore, the controller 35 recognizes the size of the respective recording areas based on the positions of the ends located based on the output of the photodetector 28. In other words, the size of each recording area is specified based on the distance between ends. Then, the unit selects a recording area having an area corresponding to the amount of information to be recorded in the recording layer from the plural recording areas included in the recording layer, and controls the beam irradiated position in the optical recording medium 10A so as to apply the information beam to the selected recording area.

Similarly, the position may be controlled based on the output of the beam intensity monitored by the two-dimensional photodetector 24. In this case, the controller 35 determines the starting position for recording and the end position for recording based on the output of the beam intensity monitored by the two-dimensional photodetector 24, and controls the beam irradiated position in the optical recording medium based on the determined position. Further, the controller 35 selects a recording area corresponding to the amount of information based on the output of the two-dimensional photodetector 24.

Further, in the optical recording and reproducing apparatus 1 illustrated in FIG. 5, the two-beam interference method is utilized so that the information beam and the reference beam may interfere, a transmissive coaxial interference method can also be utilized.

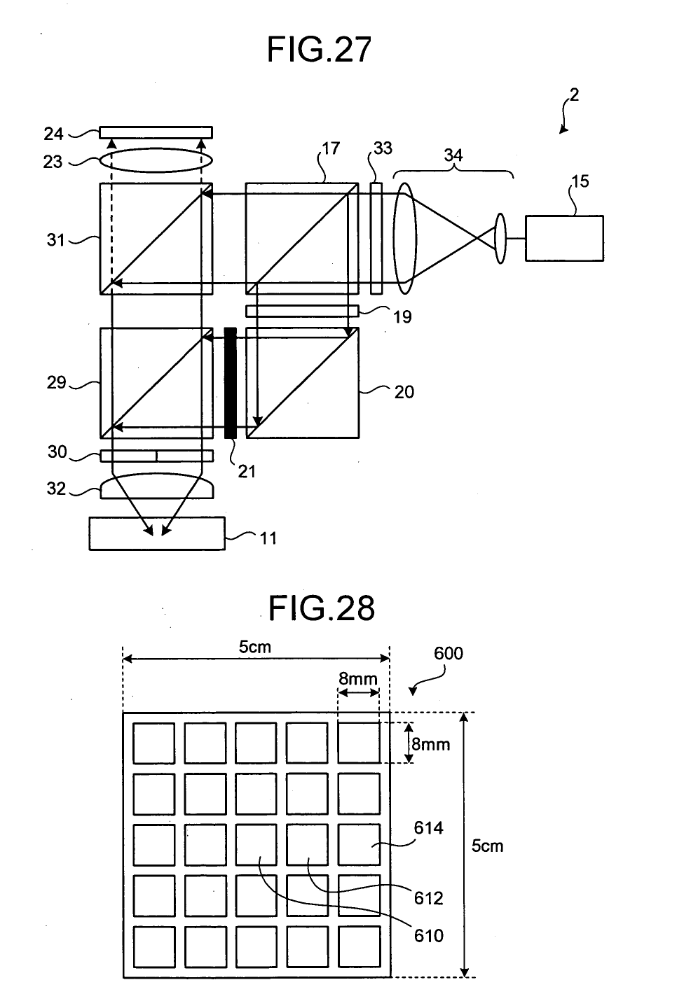

FIG. 27 is a schematic diagram of an example of a hologram type optical recording and reproducing apparatus that can mount the reflective optical recording medium 11 having the reflecting layer 18 shown in FIG. 7. A recording method using the hologram type optical recording and reproducing apparatus will be described.

This hologram type optical recording and reproducing apparatus 2 includes a reflective optical recording medium 11, a light source 15, an optical element 33 for optical rotation, a polarizing beam splitter 17, a beam expander 34, a transmissive spatial light modulator 19, a polarizing beam splitter 20, an electromagnetic shutter 21, an objective lens 32, an imaging lens 23, a two-dimensional photodetector 24, an optical element 33 for optical rotation, a polarizing beam splitter 29, an optical element 30 for two-part split optical rotation, and a beam splitter 31.

A beam output from the light source 15 has its beam diameter increased by the beam expander 34, and enters the optical element 33 for optical rotation as a parallel luminous flux.

The optical element 33 for optical rotation rotates a plane of polarization of the beam or turns the beam into circularly polarized beam or elliptically polarized beam, and thereby, outputs beam including a polarization component with a plane of polarization in parallel with the paper surface (hereinafter, referred to as “P-polarized component”), a polarization component with a plane of polarization perpendicular to the paper surface (hereinafter, referred to as “S-polarized component”). As the optical element 33 for optical rotation, for example, a half-wave plate or quarter-wave plate can be used.

Of the beams output from the optical element 33 for optical rotation, the S-polarized component is reflected by the polarizing beam splitter 17 and enters the transmissive spatial light modulator 19. Further, the P-polarized component is transmitted through the polarizing beam splitter 17. This P-polarized component is utilized as reference beam.

The transmissive spatial light modulator 19 has many pixels arranged in a matrix form like a transmissive liquid crystal display device, for example. The transmissive spatial light modulator 19 can switch the output beam between the P-polarized component and the S-polarized component with respect to each pixel. Thus, the transmissive spatial light modulator 19 outputs information beam provided with a two-dimensional distribution of plane of polarization corresponding to the information to be recorded.

The information beam output from the transmissive spatial light modulator 19 then enters the polarizing beam splitter 20. The polarizing beam splitter 20 reflects only the S-polarized component and transmits the P-polarized component of the information beam.

The S-polarized component reflected by the polarizing beam splitter 20 passes through the electromagnetic shutter 21 as information beam provided with a two-dimensional intensity distribution, and enters the polarizing beam splitter 29. This information beam is reflected by the polarizing beam splitter 29 and enters the optical element 30 for two-part split optical rotation.

The optical element 30 for two-part split optical rotation has different optical characteristics in the right part and the left part in the drawing. Specifically, of the information beam, for example, the light component entering the right part of the optical element 30 for two-part split optical rotation has its plane of polarization rotated +45° and is output. On the other hand, the light component entering the left part has its plane of polarization rotated −45° and is output. Hereinafter, the component formed by rotating the plane of polarization of the S-polarized component +45° (or the component formed by rotating the plane of polarization of the P-polarized component −45°) is referred to as “A-polarized component”, and the component formed by rotating the plane of polarization of the S-polarized component −45° (or the component formed by rotating the plane of polarization of the P-polarized component +45°) is referred to as “B-polarized component”. For the respective parts of the optical element 30 for two-part split optical rotation, half-wave plates can be used, for example.

The A-polarized component and the B-polarized component output from the optical element 30 for two-part split optical rotation are collected onto the reflecting layer 18 of the optical recording medium 2 by the objective lens 32. Here, the optical recording medium 11 is disposed so that the protecting layer 16 may be opposed to the objective lens 32.

On the other hand, a part of the P-polarized component (reference beam) transmitted through the polarizing beam splitter 17 is reflected by the beam splitter 31 and transmitted through the polarizing beam splitter 29. The reference beam transmitted through the polarizing beam splitter 29 then enters the optical element 30 for two-part split optical rotation, and the light component entering the right part thereof has its plane of polarization rotated +45° and is output as the B-polarized component and the light component entering the left part thereof has its plane of polarization rotated −45° and is output as the A-polarized component. Subsequently, the A-polarized component and the B-polarized component are collected onto the reflecting layer 18 of the optical recording medium 11 by the objective lens 32.

Thus, from the right part of the optical element 30 for two-part split optical rotation, information beam as the A-polarized component and reference beam as the B-polarized component are output. On the other hand, from the left part of the optical element 30 for two-part split optical rotation, information beam as the B-polarized component and reference beam as the A-polarized component are output. Further, the information beam and the reference beam are collected onto the reflecting layer 18 of the optical recording medium 11.

Accordingly, the interference of the information beam and the reference beam occurs only between the information beam as direct beam directly entering the recording area via the protecting layer 16 and the reference beam as reflected beam reflected by the reflecting layer 18 and between the reference beam as direct beam and the information beam as reflected beam. Further, no interference occurs between the information beam as direct beam and the information beam as reflected beam or between the reference beam as direct beam and the reference beam as reflected beam.

Therefore, according to the optical recording and reproducing apparatus 2 shown in FIG. 27, an optical characteristic distribution corresponding to the information beam can be produced within the recording area 120.

The information recorded by the above described method can be read out in the following manner. The electromagnetic shutter 21 is closed and only the irradiating beam is applied to the recording area in which the information is recorded previously. Thereby, only the reference beam as the P-polarized component reaches the optical element 30 for two-part split optical rotation.

Of the reference beam, by the optical element 30 for two-part split optical rotation, the light component entering the right part thereof has its plane of polarization rotated +450 and is output as the B-polarized component and the light component entering the right part thereof has its plane of polarization rotated −45° and is output as the A-polarized component. Subsequently, the A-polarized component and the B-polarized component are collected onto the reflecting layer 18 of the optical recording medium 11 by the objective lens 32.

In the recording area of the optical recording medium 11, by the above described method, the optical characteristic distribution corresponding to the information is formed. Therefore, parts of the A-polarized component and the B-polarized component entering the optical recording medium 2 are diffracted by the optical characteristic distribution formed within the recording area and is output as reproduction beam from the optical recording medium 11.

The reproduction beam output from the optical recording medium 11 reproduces the information beam, and is made into parallel luminous flux by the objective lens 32, and then, reaches the optical element 30 for two-part split optical rotation. The B-polarized component entering the right part of the optical element 30 for two-part split optical rotation is output as the P-polarized component and the A-polarized component entering the left part of the optical element 30 for two-part split optical rotation is output as the P-polarized component. Thus, the reproduction beam as the P-polarized component is obtained.

Subsequently, the reproduction beam is transmitted through the polarizing beam splitter 29. A part of the reproduction beam transmitted through the polarizing beam splitter 29 is then transmitted through the beam splitter 31, and imaged by the imaging lens 23 so as to reproduce the image of the transmissive spatial light modulator 19 on the two-dimensional photodetector 24. Thus, the information recorded in the optical recording medium 11 is read out.

On the other hand, the rest of the A-polarized component and the B-polarized component transmitted through the optical element 30 for two-part split optical rotation and entering the optical recording medium 11 is reflected by the reflecting layer 18 and output from the optical recording medium 11. The A-polarized component and the B-polarized component as the reflected beam is made into parallel luminous flux by the objective lens 32, and then, the A-polarized component enters the right part of the optical element 30 for two-part split optical rotation and is output as the S-polarized component and the B-polarized component enters the left part of the optical element 30 for two-part split optical rotation and is output as the S-polarized component. The S-polarized component output from the optical element 30 for two-part split optical rotation can not reach the two-dimensional photodetector 24 because it is reflected by the polarizing beam splitter 29. Therefore, according to the optical recording and reproducing apparatus 2, an advantageous SN ratio can be realized.

When the optical recording medium 11 shown in FIG. 7 is mounted on the above described optical recording and reproducing apparatus, the end of the recording area can be detected utilizing at least one of the information beam and the reference beam at the time of writing. Further, the starting position for recording 450 described by referring to FIG. 13 can be located. Here, a light source for detecting the end of the recording area 120 may be provided separately.

As a detecting method of the end of the recording area, there is a method based on the output of the light intensity transmitted through an optical medium monitored by the two-dimensional photodetector 24. When servo beam or reference beam used as servo beam illuminates the end of the recording area, beam is scattered strongly. Thereby, a spike output is obtained from the two-dimensional photodetector 24. Using this spike output as a detection signal of the end of the recording area, the end of the recording area can be detected.

Hereinafter, a specific example 1 of the optical recording medium according to the embodiment will be described.

In this example 1, the transmissive optical recording medium 10A shown in FIGS. 1 and 2 is fabricated by the following method.

First, 3.86 grams (g) of vinylcarbazole and 2.22 g of vinylpyrrolidone are mixed. Then, 0.19 g of IRGACURE 784 (manufactured by Ciba Specialty Chemicals K.K.) is added and agitated. After all of the mixed materials are dissolved, 0.04 g of PERBUTYL H (manufactured by NOF Corporation) is mixed to the mixture to further prepare a monomer solution A. Next, 10.1 g of 1,4-butanediol diglycidyl ether and 3.6 g of diethylenetriamine are mixed to prepare an epoxy solution B. Further, 1.5 milliliters (ml) of the monomer solution A and 8.5 ml of the epoxy solution B are mixed and defoamed to prepare an optical recording medium precursor.

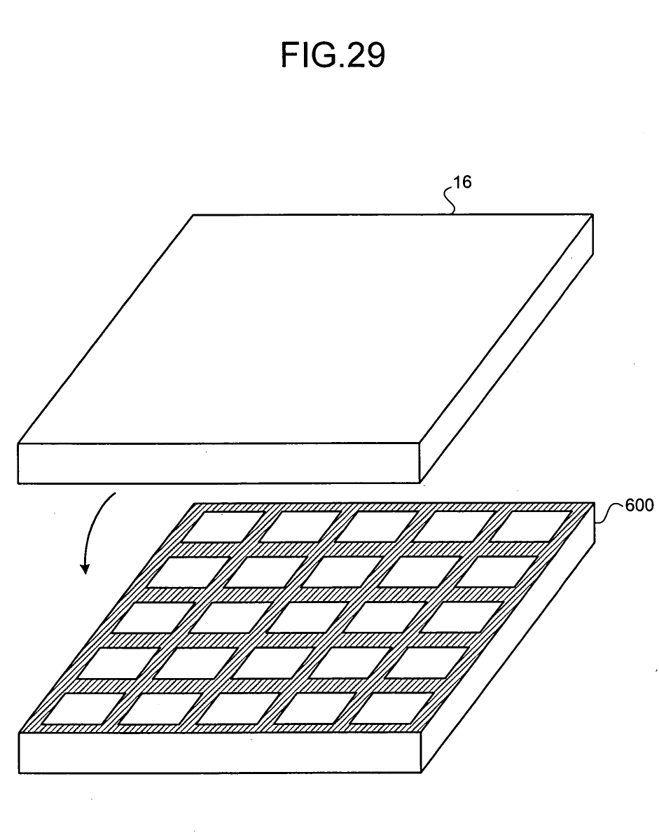

Then, the mixed solution is casted in a spacer having a thickness of 250 micrometers (μm) made of fluorocarbon resin placed on a quartz glass substrate having a thickness of 0.5 millimeter (mm) in a square shape with 5 centimeters (cm) side. The shape of the spacer made of fluorocarbon resin is shown in FIG. 28. After casting, a quartz glass substrate 16 that is separately prepared is opposingly disposed as shown in FIG. 29. Further, by applying uniform pressure, the above described mixed solution is drawn to the thickness of 250 μm. Finally, it is let stand for 24 hours at room temperature, and thereby, the optical recording medium 10A having the recording area having a thickness of 250 μm is fabricated. In the optical recording medium 10A fabricated in the example, the spacer made of fluorocarbon resin forms the boundary area 130 shown in FIG. 1 and the upper quartz glass substrate forms the protecting layer 16. Note that the series of operations are performed within a room shielded against light having a wavelength shorter than 600 nanometers (nm) in order not to expose the recording area 120 to light.

Next, an example in which the optical recording medium 10A fabricated by the above described method is mounted to the transmissive optical recording and reproducing apparatus 1 shown in FIG. 26 and recording of information is actually performed will be described. Here, second harmonic wave (532 nm in wavelength) of a neodymium YAG laser is used as coherent light output from the light source 15, half-wave plates are used as the optical elements 33 and 25 for optical rotation, and a liquid crystal panel is used as the transmissive spatial light modulator 19. Further, the orientation of the half-wave plate used as the optical element 33 for optical rotation is adjusted so that intensity of the information beam and the reference beam may be equal on the surface of the optical recording medium 10A. Furthermore, here, the light intensity of the information beam and the reference beam on the surface of the optical recording medium 10A at the time of recording is 0.5 megawatt (mW), and the spot size of the laser beam on the upper surface of the recording area 120 is 3 mm in diameter.

The starting position for recording is determined by applying only the reference beam to the optical recording medium 10A. In other words, only the reference beam having intensity of 0.01 mW on the surface of the optical recording medium 10A is applied to the optical recording medium 10A. Then, while monitoring the output of the photodetector 28, the optical recording medium 10A is moved in a direction perpendicular to the optical axis of the objective lens 22. The position where the output from the photodetector 28 becomes unchanged is defined as the starting position for recording. The starting position for recording is at a distance of 1.5 mm from the end of the recording area 120.

Next, an example in which the information recorded in the optical recording medium 10A by the above described method is read out using the recording and reproducing apparatus 1 shown in FIG. 26 will be described. At the time of reading out, by adjusting the orientation of the half-wave plate used as the optical element 33 for optical rotation, the intensity of the reference beam on the surface of the optical recording medium 10A is made 0.1 mW. Further, a CCD array is used as the two-dimensional photodetector 23.

As a result, it is confirmed that writing and reading of information can be well performed on the optical recording medium 10A before being exposed to the ambient light.

Further, it is confirmed that, in the case of recording information in the above described manner, at the time of determination of the starting position for recording, when the recording is performed in a position where the output from the photodetector 28 still varies, because the wavefronts of the information beam and the reference beam are disturbed by the boundary area 130, good writing and reading of information can not be performed.

Next, an example in which an evaluation of recordable performance is conducted on the optical recording medium 10A will be described. Here, the method of evaluation of the recording performance of the transmissive hologram recording medium will be described. In the practical embodiment, as an index of the recording performance of hologram, M/# (M number) representing the recording dynamic range is used. M/# is expressed as below (by the equation 1) when multiple recording and reproducing n pages of holograms by the time recording can not be performed in the same area within the recording layer of the hologram recording medium, where the diffraction efficiency from the ith hologram is ηi.

$$M / \# = {\sum }_{i = 1}^{n} \sqrt{ni} \qquad Equation 1$$

The larger the value of M/# of a hologram recording medium, the larger the recording dynamic range and the more advantageous the multiple recording performance.

In the example, when only the reference beam is applied to the optical recording medium 10A in FIG. 8, provided that the light intensity detected by the photodetector 28 is Iₜ and the light intensity detected by the two-dimensional photodetector 24 is I_{d}, the diffraction efficiency η is expressed by the following equation.
η=I_{d}/(Iₜ+I_{d}) Equation 2

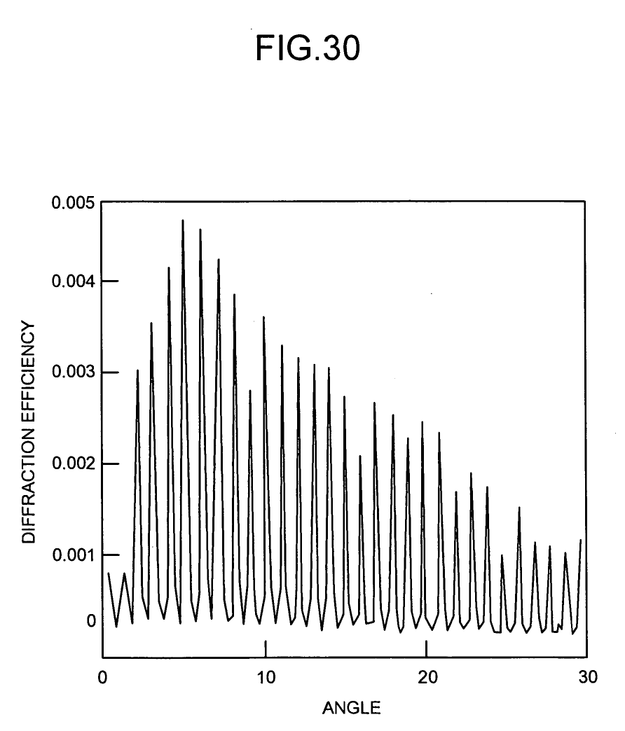

M/# is measured by performing angular multiple recording and reproduction for recording different pages while rotating the optical recording medium 10A using internal diffraction efficiency. FIG. 30 is a graph of-an example of diffraction efficiency when angular multiple recording and reproduction is performed.

The evaluation of recordable performance is performed by the following method. First, using the optical recording medium 10A immediately after being let stand for 24 hours as described in the above fabricating method of the optical recording medium, M/# is measured by performing angular multiple recording and reproduction on a recording area 610 shown in FIG. 28 by the above method with the amount of exposure per one page of hologram as 20 mJ/cm². As a result, M/# is 4. Then, using the same optical recording medium 10A in which the recording area 610 has been recorded, M/# is measured in the same measurement condition on a recording area 612 one day after M/# of the recording area 610 is measured. As a result, M/# is 3. Further, using the same optical recording medium 10A in which the recording area 610 and recording area 612 have already been recorded, M/# is measured in the same measurement condition on a recording area 614 one day after M/# of the recording area 612 is measured. As a result, M/# is 3. Note that between the measurements, the optical recording medium 10A is kept in a dark place in order not to expose it to light.

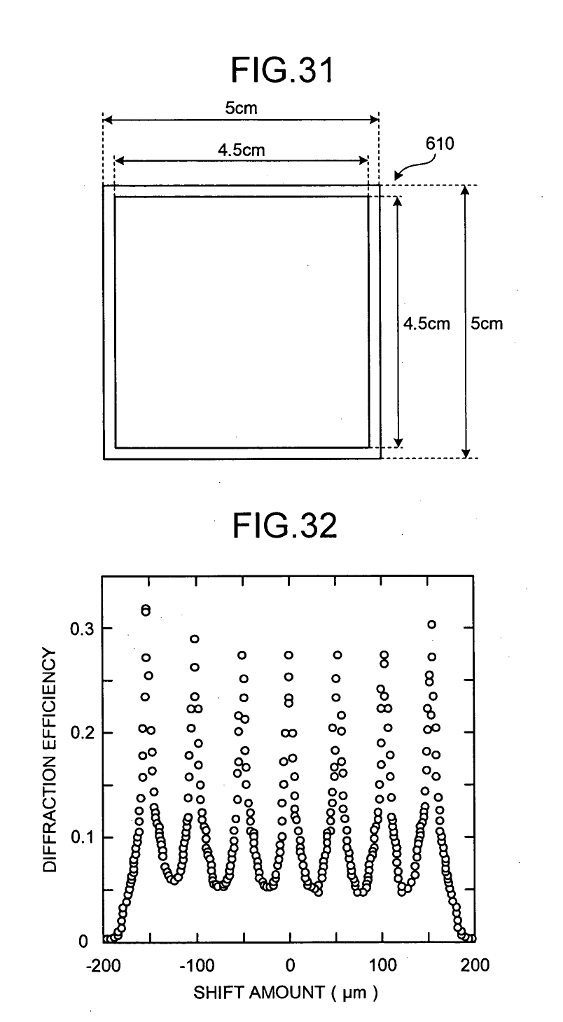

Next, the comparative example 1 will be described. In the comparative example, a transmissive optical recording medium is fabricated by the following method. Using a spacer having a shape shown in FIG. 31 and a thickness of 250 μm made of fluorocarbon resin, a transmissive optical recording medium having a recording area having a thickness of 250 μm is fabricated by the same method as described in the example 1.

Then, as the comparative example 1, the evaluation of recordable performance is performed. By the same method as in the example 1, using the optical recording medium immediately after being fabricated, M/# is measured with the amount of exposure per one page of hologram as 20 mJ/cm². As a result, M/# is 4. Then, using the same optical recording medium, M/# is measured in the same measurement condition on an unrecorded area 8 mm apart from the recording position where the above described M/# is measured one day after the above described M/# is measured. As a result, M/# is 1. Further, using the same optical recording medium, M/# is measured in the same measurement condition on an unrecorded area 8 mm apart from the recording position where the above described M/# is measured one day after. As a result, M/# is 0.5. Note that between the measurements, the optical recording medium is kept in a dark place in order not to expose it to light.

Thus, regarding the optical recording medium according to the comparative example 1, the recording performance of the unrecorded area is drastically deteriorated by the influence of the recorded area. On the contrary, in the optical recording medium 10A according to the example 1, the recording performance is hardly deteriorated between the recording area 612 and the recording area 614. Thus, it is confirmed that the optical recording medium 10A according to the example 1 has advantageous recordable performance.

Hereinbelow, the specific example 2 of the optical recording medium according to the embodiment will be described.

In this example, the reflective optical recording medium 11 shown in FIG. 7 is fabricated by the following method. First, as the reflecting layer 18, a quartz glass substrate 3 having a thickness of 0.5 mm in a square shape with a side of 5 cm and an aluminum layer having a thickness of 200 nm formed on one side by sputtering is prepared. Then, by the same method described in the example 1, a mixed solution for forming recording areas is prepared, a spacer having a thickness of 250 μm made of fluorocarbon resin is placed on an opposite surface of the quartz glass substrate to the previously prepared aluminum layer, and the mixed solution is casted in the spacer. The shape of the spacer made of fluorocarbon resin is the same as the shape of the spacer according to the example 1 described with reference to FIG. 28. After casting, a quartz glass substrate 16 that is separately prepared is opposingly disposed, and further, by applying uniform pressure, the above described mixed solution is drawn to the thickness of 250 μm. Finally, it is heated at 50° C. for 10 hours, and the optical recording medium 11 having the recording area having a thickness of 250 μm is fabricated. In the optical recording medium 11 fabricated in the example, the spacer made of fluorocarbon resin forms the boundary area 130 and the upper quartz glass substrate forms the protecting layer 16. Note that the series of operations are performed within a room shielded against light having a wavelength shorter than 600 nm in order not to expose the recording area 120 to light.

Next, an example in which the optical recording medium 11 fabricated by the above described method is mounted to the reflective optical recording and reproducing apparatus 2 shown in FIG. 27 and recording of information is actually performed will be described. Here, second harmonic wave (532 nm in wavelength) of a neodymium YAG laser is used as coherent light output from the light source 15, a half-wave plate is used as the optical element 33 for optical rotation, and a liquid crystal panel is used as the transmissive spatial light modulator 19. Further, the orientation of the half-wave plate used as the optical element 33 for optical rotation is adjusted so that intensity of the information beam and the reference beam may be equal on the surface of the optical recording medium 11. Furthermore, here, the light intensity of the information beam and the reference beam on the surface of the optical recording medium 11 is made 0.1 mW, and the spot size of the laser beam on the upper surface of the recording area 120 is 500 μm in diameter.

The starting position for recording is determined by applying only the reference beam to the optical recording medium 11. Only the reference beam having intensity of 0.002 mW on the surface of the optical recording medium 11 is applied to the optical recording medium 11, while monitoring the output of the two-dimensional photodetector 24, the optical recording medium 11 is moved in a direction perpendicular to the optical axis of the objective lens 32, and the position where the output from the two-dimensional photodetector 24 becomes unchanged is defined as the starting position for recording. The starting position for recording is at a distance of 250 μm from the end of the recording area 120.

Next, the information recorded in the optical recording medium 11 by the above described method is read out using the recording and reproducing apparatus shown in FIG. 27. At the time of reading out, by adjusting the orientation of the half-wave plate used as the optical element 33 for optical rotation, the intensity of the reference beam on the surface of the optical recording medium 11 is made 0.02 mW. Further, a CCD array is used as the two-dimensional photodetector 23. As a result, it is confirmed that writing and reading of information can be well performed on the optical recording medium 11 before being exposed to the ambient light.

Further, it is confirmed that, in the case of recording information in the above described manner, at the time of determination of the starting position for recording, when the recording is performed in a position where the output from the two-dimensional photodetector 24 still varies, because the wavefronts of the information beam and the reference beam are disturbed by the boundary area 130, good writing and reading of information can not be performed.

Next, an evaluation of recordable performance is performed on the optical recording medium 11. First, the method of evaluation of the recording performance of the reflective hologram recording medium will be described. For the reflective hologram recording medium, because the angular multiple recording described in the example 1 is difficult, the evaluation of the recording performance is conducted by the shift multiple recording for multiple recording the hologram while moving the optical recording medium in parallel. The shift multiple recording is performed in the following manner. After the hologram is recorded in the optical recording medium 11 by the method used when recording information, the optical recording medium 11 is moved 50 μm in parallel in a direction perpendicular to the optical axis of the objective lens 32 to record a different hologram. The shift multiple recording is performed by repeating the operation plural times. FIG. 32 is a graph of an example of diffraction efficiency when performing shift multiple recording.

Next, in the practical embodiment, as an index representing the recording dynamic range, a value m/# is defined. m/# is defined as below. When multiple recording and reproducing 20 pages of holograms, provided that the diffraction efficiency from the ith hologram is ηi, m/# is defined as the following equation 3.

$$M / \# = {\sum }_{i = 6}^{15} \sqrt{η i} \qquad Equation 3$$

Similar to M/# in the example 1, the larger the value of m/# of a hologram recording medium, the larger the recording dynamic range and the more advantageous the multiple recording performance. The diffraction efficiency η is calculated by the following equation.
η=Id/I×R×(1−R) Equation 4

In the equation 4, I represents the light intensity transmitted through the polarization beam splitter 17 at the time of reproduction, R represents the reflectance of the beam splitter 31, and Id represents the diffracted beam intensity measured by the CCD array 24.

The evaluation of recordable performance is performed by the following method. First, using the optical recording medium 11 immediately after being fabricated, m/# is measured by performing shift multiple recording and reproduction on the recording area 610 shown in FIG. 28 by the above method with the amount of exposure per one page of hologram as 20 mJ/cm². As a result, m/# is 5. Then, using the same optical recording medium 11 in which the recording area 610 has been recorded, m/# is measured in the same measurement condition on a recording area 612 one day after m/# of the recording area 610 is measured. As a result, m/# is 4. Further, using the same optical recording medium 11 in which the recording area 610 and recording area 612 have been recorded, m/# is measured in the same measurement condition on a recording area 614 one day after m/# of the recording area 612 is measured. As a result, m/# is 4. Note that between the measurements, the optical recording medium 11 is kept in a dark place in order not to expose it to light.

Next, the comparative example 2 will be described. In the comparative example 2, a reflective optical recording medium is fabricated by the following method. Using the spacer having a shape shown in FIG. 31 and a thickness of 250 μm made of fluorocarbon resin, a transmissive optical recording medium having a recording area having a thickness of 250 μm is fabricated by the same method as described in the example 2.

Then, as the comparative example 2, the evaluation of recordable performance is performed. By the same method as in the example 2, using the optical recording medium immediately after being fabricated, m/# is measured by performing shift multiple recording and reproduction with the amount of exposure per one page of hologram as 20 mJ/cm². As a result, m/# is 5. Then, using the same optical recording medium, m/# is measured in the same measurement condition on an unrecorded area 8 mm apart from the recording position where the above described m/# is measured one day after the above described m/# of the recording area is measured. As a result, m/# is 2. Further, using the same optical recording medium, m/# is measured in the same measurement condition on an unrecorded area 8 mm apart from the recording position where the above described m/# is measured one day after. As a result, m/# is 1. Note that between the measurements, the optical recording medium 11 is kept in a dark place in order not to expose it to light.

Thus, in the optical recording medium 11 according to the comparative example 2, the recording performance of the unrecorded area is drastically deteriorated by the influence of the recorded area. On the contrary, in the optical recording medium 11 according to the example 2, the recording performance is hardly deteriorated between the recording area 612 and the recording area 614. Thus, it is confirmed that the optical recording medium 11 according to the example 2 has advantageous recordable performance. Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concepts as defined by the appended claims and their equivalents.

1. An optical recording medium comprising:
a recording layer recording information as hologram by receiving a beam of light corresponding to the information, the recording layer including:
a plurality of recording areas which are physically separated in a direction, the direction is substantially parallel to a surface that the beam of light enters; and
a boundary area provided between the recording areas to separate the respective recording areas.

2. The optical recording medium according to claim 1,
wherein the recording area is formed in a size equal to or larger than a maximum spot size of the beam of light applied to the recording area.

3. The optical recording medium according to claim 1,
wherein the recording area is formed so that a width in a scanning direction along which the beam of light is made to run for scanning when information is recorded by-shift multiple recording, information is recorded through change in an irradiated position of the beam of light in the shift multiple recording, is equal to or more than twice as long as a diameter of a spot of the beam of light having the maximum size.

4. The optical recording medium according to claim 1,
wherein the recording area is formed so that a width in a direction perpendicular to a scanning direction along which the beam of light is made to run for scanning when information is recorded by shift multiple recording, information is recorded through change in an irradiated position of the beam of light in the shift multiple recording, is equal to or more than a diameter of a spot of the beam of light having the maximum size.

5. The optical recording medium according to claim 1,
wherein the plurality of recording areas are arranged along a scanning direction in which the beam of light is to be made to run for scanning.

6. The optical recording medium according to claim 5,
wherein the scanning direction is a linear direction in which the beam of light is to be made to run for scanning.

7. The optical recording medium according to claim 5,
wherein the optical recording medium has a disk shape and the scanning direction is a circumferential direction of the recording medium, the beam of light is to be made to run for scanning in the circumferential direction.

8. The optical recording medium according to claim 1,
wherein the recording area is formed by a material containing a photopolymer.

9. The optical recording medium according to claim 1,
wherein the boundary area is a vacant hole.

10. The optical recording medium according to claim 1,
wherein the boundary area is formed by a material containing a metal.

11. The optical recording medium according to claim 1,
wherein the boundary area is formed by a material containing a metal oxide.

12. The optical recording medium according to claim 1,
wherein the boundary area is formed by a material containing an ion-exchange resin.

13. A manufacturing method of an optical recording medium having a recording layer that records information as hologram by receiving a beam of light corresponding to the information, the method comprising:
forming a plurality of recording areas which record the information; and
forming a boundary area that physically separates the respective recording areas in a direction, the direction being substantially parallel to a surface that the beam of light enters.

14. A holographic optical recording and reproducing apparatus for recording information on an optical recording medium including a recording layer that records information as hologram by receiving a beam of light corresponding to the information, the recording layer including a plurality of recording areas and a boundary area, the plurality of recording areas are physically separated in a direction, the direction being substantially parallel to a surface that the beam of light enters, and the boundary area provided between the recording areas to separate the respective recording areas, the holographic optical recording and reproducing apparatus comprising:
an edge detecting unit that detects a edge of the recording area using the beam of light; and
a beam applying unit that applies the beam of light in a position at inner side of the edge of the recording area detected by the edge detecting unit.

15. The holographic optical recording and reproducing apparatus according to claim 14,
wherein the plurality of recording areas have different areas in size,
the holographic optical recording and reproducing apparatus further comprising:
a recording area selecting unit that selects a recording area having an area suitable for an amount of information to be recorded in the recording layer from the recording areas.

16. The hologram type optical recording and reproducing apparatus according to claim 14, further comprising:
a position locating unit that locates a position within the recording area by a length equal to or longer than a radius of a maximum spot size of the beam of light based on the edge detected by the edge detecting unit,
wherein the beam applying unit applies the beam of light in a position at inner side of the position located by the position locating unit in the recording area.

17. The hologram type optical recording and reproducing apparatus according to claim 14,
wherein the recording area is formed in a size equal to or larger than a maximum spot size of the beam of light applied to the recording area.

18. The hologram type optical recording and reproducing apparatus according to claim 14,
wherein the recording area is formed so that a width in a scanning direction along which the beam of light is made to run for scanning when information is recorded by shift multiple recording, information is recorded through change in an irradiated position of the beam of light in the shift multiple recording, is equal to or more than twice as long as a diameter of a spot of the beam of light having the maximum size.

19. The hologram type optical recording and reproducing apparatus according to claim 14,
wherein the recording area is formed so that a width in a direction perpendicular to a scanning direction along which the beam of light is made to run for scanning when information is recorded by shift multiple recording, information is recorded through change in an irradiated position of the beam of light in the shift multiple recording, is equal to or more than a diameter of a spot of the beam of light having the maximum size.

20. The hologram type optical recording and reproducing apparatus according to claim 14,
wherein the plurality of recording areas are arranged along a scanning direction in which the beam of light is to be made to run for scanning.
